(19) United States
(12) Patent Application Publication
(10) Pub. No.: US 2006/0088629 A1
(43) Pub. Date: Apr. 27, 2006

(54) Animal/pet treat with edible photo adhered to surface

(76) Inventor: Kristine Diana Otto, Conifer, CO (US)

Correspondence Address: Kristine Diana Otto, 31515 Griffin Dr., Conifer, CO, 80433, US

(21) Appl. No.: 11/256,909

(22) Filed: Oct. 24, 2005

Related U.S. Application Data
(60) Provisional application No. 60/622,421, filed on Oct. 26, 2004.

(51) Int. Cl. A22C 17/10

(52) U.S. Cl. 426/87

(57) ABSTRACT

The invention is an animal or pet treat with an edible photo adhered to its surface. This invention uses existing edible film that is intended for human consumption, human-grade food coloring as ink and a proven printing process in a new and useful way, on animal/pet treats. Pets refer most commonly to dogs, horses and cats. Animals refer most commonly to all other animals such as zoo animals. Treats are defined as food intended to be offered on an occasional basis. This is a new and useful product for individuals and businesses alike in that it provides the ability to personalize pet treats in a very unique and exceptionally detailed way.

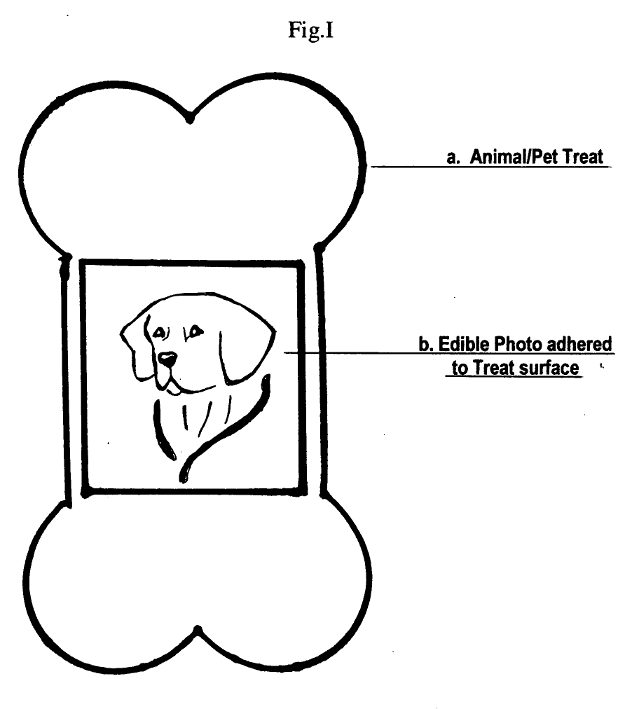

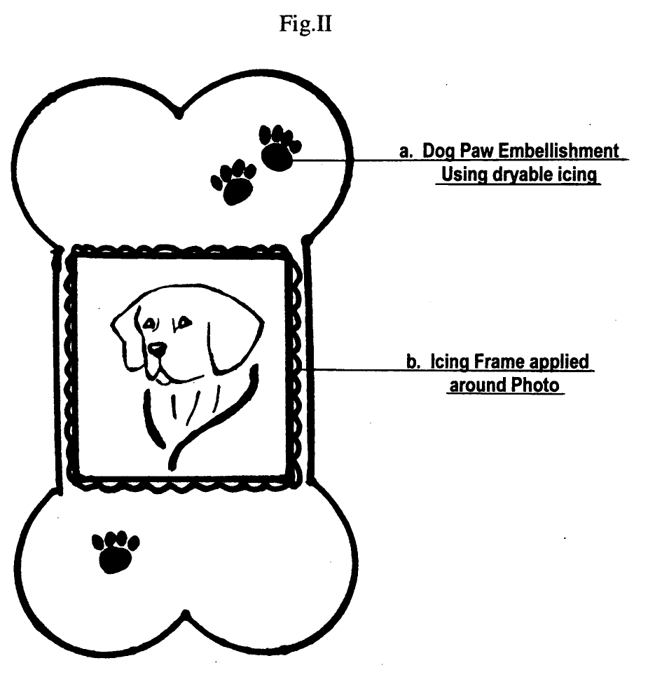

### CROSS-REFERENCE TO RELATED APPLICATIONS

### U.S. Patent Documents

Patent No.

U.S. Pat. No. 5,035,907 July, 1991 Phillips et al. Discusses decorating pastries.

U.S. Pat. No. 6,210,731 April, 2001 Brissonneau Discusses printed decorations for pastry.

U.S. Pat. No. 6,319,530 November, 2001 Stewart Discusses a method of photocopying an image onto an edible substrate for decorating iced baked goods.

U.S. Pat. No. 6,432,462 August, 2002 Brissonneau Discusses printed decorations for pastry.

U.S. Pat. No. 6,582,742 June, 2003 Stewart Further discusses a method of photocopying an image onto an edible substrate for decorating iced baked goods referring to November 2001 U.S. Pat. No. 6,319,530.

U.S. Pat. No. 6,616,958 September, 2003 Stewart Discusses a method of using an edible film for decorating foodstuffs, in particular baked goods.

U.S. Pat. No. 6,652,897 November, 2003 Stewart Discusses decorating a cake with a printed edible sheet by using an ink jet printer.

U.S. Pat. No. 6,903,841 June, 2005 Spurgeon Discusses a system for creating a decorative edible from a selected image to be used for decorating a bakery product.

### BACKGROUND OF THE INVENTION

The use of edible photos on human baked goods, most often cakes and cookies, has become quite popular. Most people bakeries offer this technology as a way to individualize their products specific to each customer. For example, birthday cakes can feature an edible photo of the birthday person and graduation cakes can feature a picture of the graduate. In addition to personal photographs, an almost limitless library of pictures can be printed on edible film and used to decorate baked goods. Cartoon characters, logos, artwork, basically any image that can be legally reproduced, can be utilized. U.S. Pat. No. 6,903,841 discusses a system for creating a decorative edible item from a selected image to be used on a bakery product. U.S. Pat. No. 6,625,897 explains decorating a cake with a printed edible sheet by using an ink jet printer. U.S. Pat. No. 6,616,958 gives a method of making and using an edible film or paper for decorating foodstuffs, in particular baked goods. All the above refer to baked goods for human consumption.

My invention entails the new and useful process of using edible photos on animal/pet treats. It provides the ability to personalize animal/pet treats in a very unique and exceptionally detailed way. Current personalization of pet treats is rudimentary, at best, as compared to this invention. The current most common method of personalization entails an imprint in the treat itself. For example most of us are familiar with the popular “Milkbones” dog treats with the same word indented on each dog biscuit. Other attempts at individualization use different shapes, sizes, colors, recipes, ingredients or packaging in their products. These methods provide more of a mode for uniqueness of a product in general, not personalization for a specific client. My invention provides for one-of-a-kind personalization. For example, an edible photo of your dog can be put on a dog treat for you.

### BRIEF SUMMARY OF THE INVENTION

The invention of an animal/pet treat with an edible photo adhered to its surface provides a new and useful product for individuals and businesses alike. It provides the ability to personalize animal/pet treats in a very unique and exceptionally detailed way. A photo of a specific animal can be adhered to the flat surface of a treat nutritionally intended and approved for that specific animal.

This far exceeds the abilities of the existing methods of personalization such as imprinting on treats.

### BRIEF DESCRIPTION OF THE DRAWING

FIG. I is a view of a pet/animal treat with an edible photo adhered to its' surface.

FIG. II is a view of the invention with optionally added royal icing frame around photo and dog paw embellishments.

### DETAILED DESCRIPTION OF INVENTION

The invention is an animal/pet treat with an edible photo adhered to its surface. This invention uses existing edible film, edible ink and printing process in a new and useful way, on pet treats. Pets refer most commonly to dogs, horses and cats, but can include any animal. Treats are defined as food intended to be offered on an occasional basis.

The invention and the process by which it is made involves three items.

(1) The Animal/Pet Treat itself

(2) The Edible photo which includes
a. edible film
b. edible ink
c. printing system

(3) The Method and product by which photo is adhered to treat

The invention is shown in FIG. I It includes the a drawing of a treat with the edible photo adhered to its surface.

### Requirements of the Animal/Pet Treat

The animal/pet treat must have a relatively smooth, flat surface to adhere the picture to. A specific example of surface texture would be that the surface not be any rougher than a person's graham cracker. Larger bumps or unevenness on the surface result in unwanted distortion of the picture and ultimate breaking and cracking of the picture itself. The pet treat must also be dry or dehydrated to the point that no cracking, bending or physical changes occur to the treat once the picture is adhered. Any of these changes in the treat will result in picture breakage. A moisture content of 8% maximum is suggested in the treat to avoid these problems.

The treat can be of varied shape and size, but it is recommended that it be large enough to accommodate no smaller than a 1″×1″ picture. Any smaller and the picture becomes difficult to discern. An ideal picture size is approximately 2″×2½″. This provides a clear, easy to see image. Instructions can be provided to consumer to break the treat in pieces for smaller pets or animals, if necessary.

The ingredients of the treat can be varied, depending on the type of animal or pet it is for. The individual dietary requirements for any given animal (dog, cat, horse etc.) would be taken into consideration in each case. State rules and regulations for pet food, which includes “treats”, are available under commercial feed law. Special needs diets such as low calorie, salt free, vegetarian, etc. can be accommodated in most cases. The treat itself can use any recipe as long as it adheres to the recommendations listed above. (moisture content, stability, size) Limitations to the special needs diets involve possible intolerability to the ingredients of the edible picture itself.

### The Edible Photo

The edible photo consists of an edible film, edible ink and the process by which to print the image on the paper.

The edible film is intended for human consumption. It is available through several different companies and manufacturers. It is sometimes referred to as an edible paper. Although there are variations in the film, the most common main ingredients are cornstarch, cellulose, tapioca starch, corn syrup, glycerin and variations thereof. Note that some papers do not contain glycerin. This type of paper is not recommended in that photos printed on this type of paper and adhered to the treat usually crack within 48 hours under dry conditions. There is also a rice paper available that has not preformed well under this use. Before being adhered properly to the pet treat, the edible film is quite sensitive to the environment It must be kept tightly sealed in an airtight bag and only removed when it is ready to be used. It is also time/age sensitive and must be used by the recommended expiration date for best results.

The edible ink used is most often artificial food coloring. A minute amount is used on each treat. This food coloring is F.D.A. approved since its intended use is on human food products. This use of artificial food coloring in pet treats has been deemed harmless to pets Under the “Rules and Regulations for Pet Food Under the Colorado Commercial Feed Law, Sections 35-60-101 through 115, C.R.S.”, Section 7 Additives and Drugs: “An artificial color may be used in a pet food or a specialty pet food only if it has been shown to be harmless to pets or specialty pets. The permanent or provisional listing of an artificial color in the United State Food and Drug Administration regulations as safe for use, together with the conditions, limitations, and tolerances, if any, incorporated therein, shall be deemed to be satisfactory evidence that the color is, when used pursuant to such regulation, harmless to pets or specialty pets.” The color on this invention is used within the above stated regulations.

There also exists a natural food coloring that contains no artificial ingredients. It is available through select “health food” suppliers. Use of this coloring has resulted in a lesser quality product (colors not true) and more frequent clogging of printer heads. It is not recommended for reliable, consistent use, but may prove useful for special needs dietary requirements.

The artificial food coloring ink is available through several different companies/manufacturers. It is provided either in a pre-filled printer cartridge or as a system whereby one can fill or refill their own cartridges with a syringe. (provided in the refill kit) The natural food coloring is not available in printer cartridges and one must manually fill clean, empty cartridges with a syringe.

The printing system by which the picture is printed on the edible film is varied in price, complexity to user and extent of manipulation. Degree of manipulation of the picture with respect to size, quality, color and artistic variations depends on the system chosen. Edible printing systems that are self-inclusive or provide everything you need to produce a finished edible picture tend to be easiest to use, but offer fewer degrees of manipulation of the picture. Printer/scanner systems that have been modified to accept edible ink and paper are also available. They require hook up to a computer, so from that stand point are not as user friendly. A degree of computer knowledge would be required for this set up. But they do offer a much larger degree of manipulation of the picture, especially with a computer-savvy user.

There are two options in which a printing system would not be needed. First, preprinted edible pictures are available with a library of select images. Certain licensed properties such as Disney and many cartoon characters are included in these. These pictures are limited with respect to this invention because the majority of the pictures are large, with the intended use on people's cakes. Also choices are limited, without the ability to fully customize this invention. Secondly, custom pictures can be special ordered from a variety of sources. These offer much more variation than the above option, but are quite costly.

As an aside, the edible paper may be drawn on manually, without the use of a printing system. Edible ink markers, widely on the market now, may be used. Applying food coloring like a “paint” is possible also. Any artists' tools may be used such as paint brushes, sponges, rubber stamps, imprints etc. This manual method is not recommended due to its time-consuming aspects and difficulty to work with the paper. There is a rolled fondant paper that is available through cake decorating supply companies that lends itself much better to hand techniques. It does not tear or dry out as quickly or easily as the edible printer paper, allowing the artist more time and flexibility for drawing. The disadvantages of this paper are cosmetic, price, and again, time consumption. It may be useful under particular conditions and requirements though.

### Adhering Picture to Treat

The picture is adhered to a flat surface of the treat using a possible variety of adherents. A paper-thin layer of adherent is spread evenly and smoothly of the back of the picture, being careful to cover the entire surface. A small 4″-4½″(blade length) angle spatula, commonly used in cake decorating, is most effective in applying the adherent. When using larger pictures, (over 5″), a larger angle spatula (8″ blade length) is suggested. Once the moist adherent is applied to the picture, the picture tears very easily. Therefore, the least amount of manipulation of the picture is recommended. Use no more than three strokes of the spatula to spread the adherent. Once the adherent is applied, gently press picture onto treat. Do not rub, as the picture easily tears. Also avoid any moisture getting on the picture. The ink runs when any water or excess moisture gets on it. Hands, working surface and tools should be totally dry. It is also possible to apply the adherent directly to the surface of the treat instead of onto the edible picture. This method does not usually work as well in that it is much more difficult to spread the adherent thinly and to be able to get it to coat the total surface of the picture. It is especially difficult with rougher surfaced treats. This method is only plausible if the treat has a very flat and smooth surface.

The composition of the adherent can vary depending on the nutritional requirements or limitations of the animal, flavor preferences or palatability for that animal, and color of the picture being applied. Light colored pictures are semi-transparent and display best when a white or light colored adherent is used. Darker pictures will tolerate a darker colored adherent without great loss of quality. The adherent must also possess the qualities of stickiness or adhesiveness and successfully bind the picture to the treat for a long period of time (a suggested minimum of 3 months, depending on requirements of buyer). The adherent must also be easily spreadable and dry within hours of picture placement. A very effective adherent is a combination of powdered sugar and water. Proportions are 1 cup (120 grams) powdered sugar to 4 teaspoons (0.67 ounces) water. When considering using this sugar-based adherent, it may be noted that many animals and pets are tolerant of small amounts of sugar. The amount used here is often considered negliable, nonetheless.

An optional addition to the above procedure is a final application of a “frame” around the edge of the picture. This frame is shown in FIG. II, b. This adds an additional degree of strength to the adherence process. The edges of the picture will stay glued down better, especially under rough conditions where the treats may rub together a lot, possibly due to packaging techniques and/or shipment. The frame can also add a more finished and artistic quality to the product. The frame recipe is a royal icing recipe (readily available in cake decorating literature and information) revised to be acceptable to each particular animal.

The revised recipe for dogs and horses is as follows: 1 cup (120 Grams) powdered sugar, ⅓ cup (approx. 80 grams) unsweetened carob powder, 1 Tablespoon (approx. 12.5 grams) powdered egg whites, ⅛ teaspoon (approx. 0.5 grams) cream of tartar, 3½ tablespoons (approx. 60 ounces) water. Beat 7 minutes medium speed with electric mixer. Royal icing and these derivatives dry hard within 24 hours. The frame is applied using basic cake decorating techniques. A pastry bag with a round #3 tip is used to pipe the frame using the shell border technique. Variations of this border and tip # are possible depending on artists' preference and the treat/picture size. Artistic additions can also be added to the treat with this royal icing. For example, paw prints, names, initials, hearts, polka-dots etc. can personalize the treat more. Examples of these embellishments (paw prints) are shown in FIG. II a. The addition of the frame and artistic embellishments are dependent on the experience of the maker in the cake decorating field. Its desirability must be weighed in light of the additional cost in time and materials.

### Uses

This invention of an animal/pet treat with an edible photo adhered to its surface provides a new and useful product for individuals and businesses alike. It provides the ability to personalize animal/pet treats in a very unique and exceptionally detailed way. In the following discussion of this invention's possible uses, the invention may be referred to as PhotoTreats. (doggie PhotoTreats, kitty PhotoTreats, horse PhotoTreats, zoo PhotoTreats, pet PhotoTreats etc.)

Animal/pet photographs,business/organization logos, names, trademarks, cartoons, artwork and information can be put on treats intended for any pet or animal. The personalized treats can then be sold for profit or fund-raising or given away as promotional items. Any individual or organization in the pet or animal fields may find these PhotoTreats useful. Pet care providers such as veterinarians, day care centers (doggie day-care), animal shelters, groomers, massage therapists, physical therapists, dog walkers, pet sitters etc. could benefit. Pet product sales including retail, wholesale and web-stores can use these personalized treats as a new and useful method of advertising or sales income. Zoos or specialized animal centers can feature unique animals or newborn animals to bring attention to their facility. Search and rescue organizations (including FEMA) that utilize rescue dogs can benefit from this invention, as can K-9 police units. Animal rights activists and organizations to protect endangered species can identify their causes using these treats. The list is nearly endless.

Event coordinators can use this invention also. Animal competitions (such as dog agility events, disc dog contests, horse races, horse competitions, etc.) could have their event logo put on the treats. Competitive animal shows can use these PhotoTreats as prizes and/or for sales revenue. They can feature the winning animal(s) or categories of competitors. (such as in dog shows, provide dog treats with pictures of toy breeds, working dog breeds, etc.) Again the event logo can be used. In light of the popularity of dogs, this invention lends itself exceptionally well for dog treats.

Individual pet owners and their friends/acquaintances can use pet PhotoTreats for enjoyment and gift giving. It is a new and unique way to personalize treats for that special pet. One's own pet can be featured on the treat. For example, an individual's dog can be featured. Great excitement and enthusiasm is shown and experienced by the owner when they receive treats with a picture of their own dog on them. The dog is doubly rewarded by the happiness/enthusiasm of their owner and the yummy treat.

In conclusion, the above-described invention is a new and useful animal/pet treat with an edible photo adhered to its surface and the manner and process of making and using this invention.—Animal/Pet PhotoTreats.

What I claim as my invention is:

1. An animal or pet treat comprising: a) an edible base layer; b) a consumable photo made from digestable film and human grade food coloring; and c) attachment of the photo to the base layer using an edible adherent.

2. An animal/pet treat in accordance with claim I wherein said adhered consumable photo provides the ability to personalize and individualize products in a unique and exceptionally detailed way for each individual consumer.

3. An animal/pet treat in accordance with claim I wherein said consumable photo film is manufactured with the original purpose of human consumption.

4. An animal/pet treat in accordance with claim I wherein said edible base layer be nutritionally safe and adequate as a “treat” for each individual type of animal it is intended for, many which “treat” guidelines are dictated by the Department of Agriculture.

5. An animal/pet treat in accordance with claim I wherein said edible adherent meet the appropriate nutritional guidelines for each individual type of animal that it is intended for.

6. An animal/pet treat in accordance with claim I wherein said edible base layer can be cut out in different shapes and sizes and baked to resemble a human “sugar cookie”.

7. An animal/pet treat in accordance with claim I wherein said product can be further personalized with the addition of a “royal” or dryable icing frame and/or decor using cake decorating skills and techniques.

8. An animal/pet treat in accordance with claim VII. wherein said “royal” or dryable icing is nutritionally adequate for each individual type of animal it is intended for.
